(19) United States
(12) Patent Application Publication
(10) Pub. No.: US 2011/0016920 A1
(43) Pub. Date: Jan. 27, 2011

(54) OPTICAL ELEMENT MANUFACTURING METHOD AND OPTICAL ELEMENT MANUFACTURING APPARATUS

(75) Inventors: Shunichi Hayamizu, Hyogo (JP); Tadafumi Sakata, Hyogo (JP)

Correspondence Address: BRINKS HOFER GILSON & LIONE, P.O. BOX 10395, CHICAGO, IL, 60610, US

(73) Assignee: Konica Minolta Opto, Inc., Tokyo (JP)

(21) Appl. No.: 12/935,225

(22) PCT Filed: Mar. 24, 2009
(86) PCT No.: PCT/JP2009/055735

§ 371 Date: Sep. 28, 2010

(30) Foreign Application Priority Data
Apr. 2, 2008 (JP) 2008-096001

(51) Int. Cl. C03B 11/00; C03B 11/08; C03B 7/14

(52) U.S. Cl. 65/29.21; 65/66; 65/226

(57) ABSTRACT

In an optical element manufacturing method for press molding in which primary molten glass droplets are caused to collide with a plate to separate some of the droplets and fine droplets of a secondary molten glass that have passed through an opening are dropped onto a lower die to perform press molding, by setting the diameter of the opening of the plate in the range of 50-100% of the effective diameter of the optical functional surface provided for the lower die, manufacturing conditions for the secondary molten glass droplets can be set easily and properly, and optical elements with satisfactory quality of both appearance and optical performance can be manufactured reliably.

### TECHNICAL FIELD

The present invention relates to a manufacturing method of an optical element in which a plate having an opening is provided; a primary molten glass droplet is allowed to collide with the plate to separate a part of the same; and a fine droplet of secondary molten glass having passed through the opening is received by a lower molding die and pressed, as well as a manufacturing apparatus for the optical element.

### BACKGROUND

Over recent years, glass-made optical elements are being widely utilized as digital camera lenses, optical pick-up lenses for DVDs, mobile phone camera lenses, and optical communication coupling lenses. As such glass-made optical elements, molten glass articles manufactured via press-molding of glass materials using molding dies have been frequently used.

As a manufacturing method of a molten glass article, proposed is a method in which a molten glass droplet is dropped onto a lower molding die having been heated at a specific temperature and then the thus-dropped molten glass droplet is press-molded by the lower molding die and an upper molding die facing the lower molding die to obtain a molten glass article (referred to also as a “liquid droplet molding method”) (for example, refer to Patent Document 1). In this method, no glass preform needs to be previously produced, and also a molten glass article can directly be manufactured from a molten glass droplet without repetitive heating and cooling of a molding die, whereby the time required for a single molding cycle can extremely be shortened, resulting in much attention.

On the other hand, with miniaturization of various types of optical devices in recent years, small-sized molten glass articles have been highly demanded. It is difficult to produce a molten glass fine droplet required for production of such a small-sized molten glass article only by dropping a molten glass droplet using a nozzle. As a manufacturing method thereof; proposed is a method in which a molten glass droplet is allowed to collide with an opening member (hereinafter referred to as a plate) serving as a dropping amount adjustment member provided with an opening; and then a part of the collided molten glass droplet is allowed to pass through the opening to be separated to give a molten glass fine droplet (for example, refer to Patent Document 2).

Patent Document 1: Unexamined Japanese Patent Application Publication No. 1-308840

Patent Document 2: Unexamined Japanese Patent Application Publication No. 2002-154834

### DISCLOSURE OF THE INVENTION

Problems to be Solved by the Invention

When a molten glass fine droplet is produced by the method described in Patent Document 2, a primary molten glass droplet dropping from a nozzle is allowed to pass through an opening of a plate to separate a part thereof; and then a fine droplet of secondary molten glass is dropped onto a lower molding die. Therefore, the mass of a fine droplet of this secondary molten glass needs to be set to be a desired mass based on the design specifications of an optical element to be produced.

However, for this purpose, the mass of a primary molten glass droplet is required to be controlled, and additionally, a large number of parameters such as the opening diameter of a plate with which this primary molten glass droplet is allowed to collide, the distance between the dropping nozzle of the primary molten glass and the plate opening portion, and the melting temperature or viscosity of the primary molten glass are required to be appropriately set.

When an optical element is produced via press-molding of a secondary molten glass droplet having been dropped on a lower plate, the optical performance and the appearance quality of the optical element are affected to a large extent in some cases, depending on such condition settings. Further, thereby, the operating ratio of the production apparatus has been affected or effects on production cost have been produced in some cases. However, such a situation has been continued that to obtain an optical element of excellent quality, no simple, effective methods to optimize a large number of condition settings are available.

In view of the above technological problems, the present invention was completed. An object of the present invention is to provide, in a manufacturing method of an optical element in which a primary molten glass droplet is allowed to collide with a plate to separate a part thereof and a fine droplet of secondary molten glass having passed through an opening is dropped onto a lower molding die and press-molded, a manufacturing method and a manufacturing apparatus of an optical element in which manufacturing conditions for a secondary molten glass droplet are simply and appropriately set and thereby an optical element enabling to satisfy both qualities of appearance quality and optical performance can stably be produced.

### MEANS TO SOLVE THE PROBLEMS

To solve the above problems, the present invention has the following features.

1. In a manufacturing method of an optical element having a molten glass droplet supply step wherein a primary molten glass droplet is dropped from a dropping nozzle onto an opening member having an opening and a part of the primary molten glass droplet having passed through the opening is received as a secondary molten glass droplet by a lower molding die arranged immediately below the opening member and a press-molding step wherein the secondary molten glass droplet having been dropped on the lower molding die is pressed by an upper molding die, a manufacturing method of an optical element wherein the opening diameter of the opening member is 50%-100% of the effective diameter of an optical functional surface provided for the lower molding die.

2. The manufacturing method of an optical element, described in item 1, wherein the opening diameter of the opening member is 70%-90% of the effective diameter of the optical functional surface provided for the lower molding die.

3. The manufacturing method of an optical element, described in item 1 or 2, wherein the viscosity of the primary molten glass droplet is 0.1 Pa·s-2 Pa·s.

4. In the manufacturing method of an optical element described in item 3, the manufacturing method of an optical element wherein the opening diameter of the opening member is set based on the effective diameter of the optical functional surface provided for the lower molding die; the outer diameter of the dropping nozzle to drop the primary molten glass is set to obtain a desired mass of a primary molten glass droplet; and the desired mass of the primary molten glass droplet is set to obtain a desired mass of a secondary molten glass droplet.

5. The manufacturing method of an optical element, described in item 4, wherein the melting temperature of the primary molten glass droplet is set based on the desired mass of the primary molten glass droplet.

6. The manufacturing method of an optical element, described in items, wherein an optical element is trial-produced based on manufacturing conditions set by the method described in item 5 and the quality of a trial produced optical element is checked to reset the melting temperature.

7. A manufacturing apparatus of an optical element comprising: a nozzle dropping nozzle to which drops a primary molten glass droplet; an opening member as a droplet amount adjustment member, the opening member having an opening which separates and passes a part of the primary molten glass droplet having been dropped from the dropping nozzle and drops the part of the primary molten glass as a secondary molten glass droplet; a lower molding die arranged immediately below the opening of the opening member to receive a drop of the secondary molten glass droplet having passed through the opening; and an upper molding die which presses and molds the secondary molten glass droplet having been dropped on the lower molding die, wherein an opening diameter of the opening member is 50%-100% of the effective diameter of an optical functional surface provided for the lower molding die.

8. The manufacturing apparatus of an optical element, described in claim 7, wherein the opening diameter of the opening member is 70%-90% of the effective diameter of the optical functional surface provided for the lower molding die.

### EFFECTS OF THE INVENTION

According to the manufacturing method and the manufacturing apparatus of an optical element according to the present invention, in a manufacturing method of an optical element in which a primary molten glass droplet is allowed to collide with a plate to separate a part thereof and a fine droplet of secondary molten glass having passed through an opening is dropped onto a lower molding die and press-molded, the opening diameter of the plate is conditionally set to be 50%-100% of the effective diameter of an optical functional surface provided for the lower molding die, whereby manufacturing conditions of a secondary molten glass droplet are simply and appropriately set and thereby an optical element enabling to satisfy both qualities of appearance quality and optical performance can stably be produced.

### BRIEF DESCRIPTION OF THE DRAWINGS

FIG. 1 is a sectional view showing a schematic constitutional example of a part of a manufacturing apparatus to carry out the manufacturing method of an optical element of the present embodiment;

FIG. 2a is a sectional view showing the state when a primary molten glass droplet collides with an opening of a plate and FIG. 2b is a sectional view showing the state after a fine droplet of secondary molten glass has been separated;

FIG. 3 is a relational diagram showing the relationship between main manufacturing conditions and effects affecting the sizes (masses) of molten glass droplets under these conditions;

FIG. 4 is a graph schematically showing effects of typical manufacturing conditions on the quality of an optical element;

FIG. 5 is a flowchart showing a schematic procedure to set manufacturing conditions based on lens design specifications;

FIG. 6 is a diagram in which a procedure to set manufacturing conditions based on lens design specifications is additionally drawn for FIG. 4;

FIG. 7 is a flowchart showing one example of the manufacturing method of an optical element of the present embodiment;

FIG. 8 is a schematic view to illustrate the state where a fine droplet is separated by a plate; and

FIG. 9 is a schematic view to illustrate the state where a fine droplet is press-molded by a lower molding die and an upper molding die.

### DESCRIPTION OF THE SYMBOLS

10: plate (dropping amount adjustment member)

11: opening

12: (plate) upper surface

15: plate holding member

21: lower die

22: upper die

23: optical functional surface (transfer surface)

31: primary molten glass droplet

32: (secondary molten glass) fine droplet

33: excess glass

34: optical element

35: nozzle

36: primary molten glass

41: melting temperature

42: viscosity

43: nozzle outer diameter

44: opening diameter

51: mass of a primary molten glass droplet

52: mass of a secondary molten glass droplet

53: glass type

54: lens mass

55: lens effective diameter

### PREFERRED EMBODIMENT OF THE INVENTION

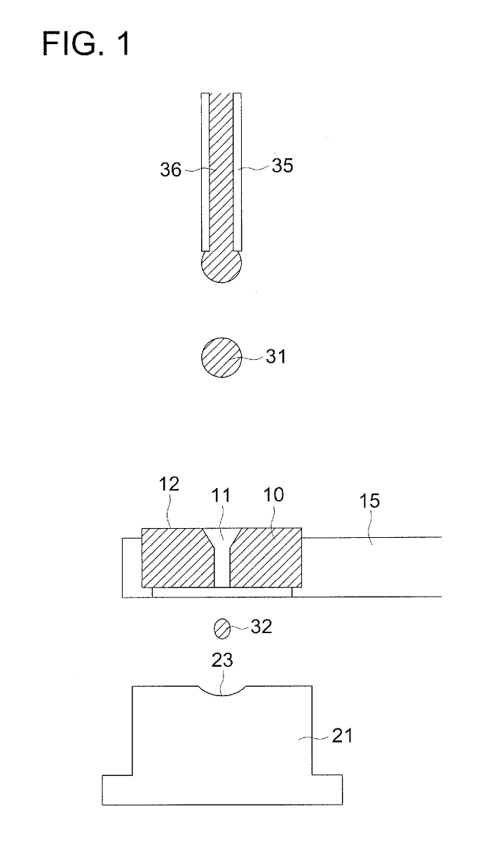

An embodiment of the present invention will now be detailed with reference to FIG. 1-FIG. 9.

(Size Reduction of a Molten Glass Droplet Using a Plate)

FIG. 1 is a sectional view showing a schematic constitutional example of a manufacturing apparatus to carry out the manufacturing method of an optical element according to the embodiment of the present invention. With reference to FIG. 1, the manufacturing method of an optical element according to the present embodiment and the constitution of the manufacturing apparatus therefor, as well as the function of an opening member (hereinafter referred to simply as a plate) as a droplet amount adjustment member will now be described.

In FIG. 1, the symbol 35 represents a nozzle to drop a primary molten glass droplet and 36 represents primary molten glass. The primary molten glass 36 having been molten in an unshown glass melting furnace at a specific temperature is supplied to the dropping nozzle 35 (hereinafter referred to simply as the nozzle), and then dropped from the tip of the nozzle 35 as shown in the drawing. The symbol 31 represents a primary molten glass droplet having been dropped. The size (mass or volume) thereof is adjusted by the melting temperature of the primary molten glass 36 and the outer diameter of the nozzle 35 tip.

The symbol 10 represents a plate having an opening 11 passing through the plate 10. The plate 10 is arranged so that a primary molten glass droplet 31 having been dropped from the nozzle 35 moves toward the center of the opening 11 for collision therewith. The symbol 15 represents an arm-shaped plate holding member to hold the plate 10 at a specific position. Namely, positioning is carried out so that the center of the opening 11 is positioned immediately below the nozzle 35 and immediately above the center of a transfer surface of a lower molding die to be described later.

The primary molten glass droplet 31 having been dropped from the nozzle 35 centrally collides with the opening 11 of the upper surface 12 of the plate 10 and then a part thereof is separated and passed through the opening 11 to drop, as a secondary molten glass droplet (hereinafter also referred to simply as a fine droplet), onto an optical functional surface (hereinafter also referred to as a functional surface or transfer surface) 23 of the lower molding die 21 arranged immediately below the opening 11. A molding process after reception of a fine droplet 32 of secondary molten glass by the lower molding die 21 will be detailed later.

The reason why a primary molten glass droplet 31 is not directly received by the lower molding die (hereinafter referred to simply as the lower die) 21 but dropped onto the plate 10 and then a part thereof is allowed to pass through the opening 11 for separation to be supplied to the lower die 21 as a fine droplet 32 of secondary molten glass is that it is difficult to reduce the size of the primary molten glass droplet 31 from the nozzle 35.

With miniaturization of various types of optical devices in recent years, optical elements featuring a small size of a diameter of several millimeters have been highly demanded. However, it is difficult to produce a molten glass fine droplet featuring a mass or volume suitable for manufacturing such small-sized optical elements only by dropping a molten glass droplet using a conventional nozzle.

The size (mass or volume) of a primary molten glass droplet 31 having been dropped from the nozzle 35 has been adjusted by the melting temperature of primary molten glass 36 and the outer diameter of the nozzle 35 tip. However, the nozzle diameter needs to be ensured to some extent to allow the primary molten glass 36 to flow and wet spreading of the primary molten glass 36 at the tip occurs, whereby the size has had a lower limit of about 200 mg. Further, when the size of the primary molten glass droplet 31 is allowed to change, the nozzle 11 needs to be replaced, whereby large effects on operating ratio and cost have been produced.

As described above, when a plate 10 having such an opening 11 is used, a fine droplet 32 having a size which is less than 200 mg can easily be obtained and also a size change of the fine droplet 32 can easily be carried out only by replacement of the plate 10.

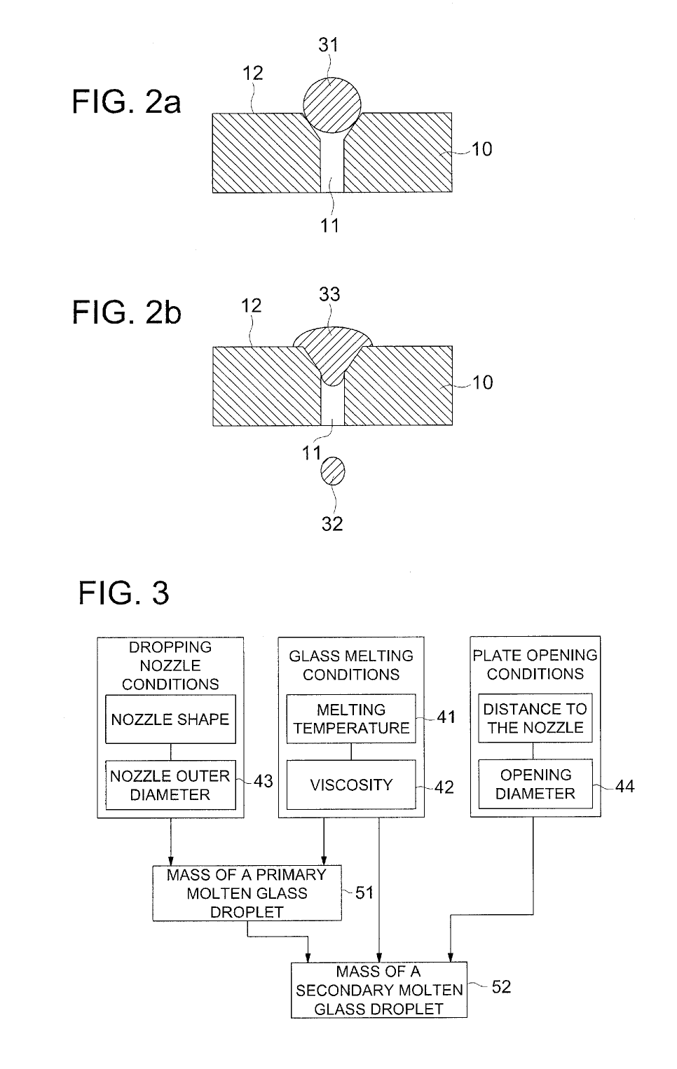

FIG. 2a is a sectional view showing the state when a primary molten glass droplet 31 collides with the opening 11 of the plate 10 and FIG. 2b is a sectional view showing the state after a fine droplet 32 has been separated. With reference to FIGS. 2a and 2b, production of the fine droplet 32 using the plate 10 will now be described.

In FIG. 2a, the symbol 31 represents a primary molten glass droplet 31 having been dropped from the nozzle 35. The state where collision against the opening 11 of the plate 10 has been just performed is shown. The opening 11 has an inner periphery surface of a taper shape on the side of the upper surface 12. The taper-shaped inner periphery surface receives the primary molten glass droplet 31.

The opening 11 has a very small diameter. However, a part of the primary molten glass droplet 31 having collided passes through the opening 11 to be separated from the primary molten glass droplet 31.

In FIG. 2b, the symbol 32 represents a fine droplet of secondary molten glass which is passed through the opening 11 and then separated from the primary molten glass droplet 31 to be dropped. The symbol 33 represents excess glass after the fine droplet 32 has been separated, being cooled and solidified in the state of penetrating into the interior of the opening 11 in the upper surface 12 of the plate 10. The thus-solidified excess glass 33 is eliminated for the drop of a subsequent primary molten glass droplet 31.

Thereafter, the fine droplet 32 is dropped onto the optical functional surface 23 of the lower die 21 having been heated and then press-molded for shape transfer of the optical functional surface 23. The size (mass) of the fine droplet 32 is previously adjusted so as to be an appropriate mass for an optical element to be formed.

The size of the fine droplet 32 can be adjusted by the inner diameter of the opening 11 (being the minimum diameter of the opening 11 and hereinafter referred to as the opening diameter). No nozzle diameter or glass melting temperature needs to be adjusted, whereby effects on molding conditions, and eventually the quality of an optical element can be minimized.

Of course, the size (mass) of the fine droplet 32 is not always determined only by the inner diameter (the minimum diameter) of the opening 11. To obtain a desired mass of the fine droplet 32, even the mass of the primary molten glass droplet needs to be controlled. Further, therewith, it is necessary to appropriately set a large number of parameters such as the dropping nozzle outer diameter of primary molten glass and the melting temperature or viscosity of the primary molten glass.

Further, to set these various conditions, the quality of an optical element to be finally formed by press-molding the fine droplet 32 must also be considered. Some of such condition settings may significantly affect the optical performance and the appearance quality of a produced optical element.

Adjustment to obtain a desired mass of the fine droplet 32 with the opening diameter of the opening 11 and setting of these various conditions must be optimized in view of quality as an optical element. Via an appropriate adjustment of the opening diameter, the manufacturing method of an optical element according to the present embodiment can simply set these manufacturing conditions to obtain a desired mass of the fine droplet 32 and stably produce an optical element enabling to satisfy both qualities of appearance quality and optical performance.

Subsequently, effects of main manufacturing conditions on the quality of an optical element will be examined and further a method and procedure for manufacturing condition setting in the manufacturing method of the present embodiment will be described.

(Production Condition Setting and Optical Element Quality)

FIG. 3 is a relational diagram showing the relationship between main manufacturing conditions and effects affecting the sizes (masses) of molten glass droplets under these conditions. With reference to FIG. 3, the dependence relationship between main manufacturing conditions and the masses of molten glass droplets is described.

These main manufacturing conditions include glass melting conditions with respect to melting of primary molten glass, dropping nozzle conditions with respect to the nozzle to drop the primary molten glass, and plate opening conditions to separate the primary molten glass droplet to obtain a secondary molten glass droplet.

The glass melting conditions mainly include melting temperature 41. The melting temperature 41 affects the viscosity 42 of molten glass and the viscosity 42 affects the mass 51 of a primary molten glass droplet dropping from the nozzle, affecting further the mass 52 of a secondary molten glass droplet which is a part of the primary molten glass droplet having been separated by the opening.

The dropping nozzle conditions include nozzle shape, nozzle inner diameter, and the nozzle outer diameter 43 of the nozzle tip. Of these, the nozzle outer diameter 43 significantly affects the mass 51 of a primary molten glass droplet. As the nozzle outer diameter 43 is increased, the mass 51 of the primary molten glass droplet is also increased.

The plate opening conditions include the opening diameter 44 of the plate and the distance between the plate and the dropping nozzle. Of these, the effect of the opening diameter 44 of the plate is produced to a large extent. As the opening diameter 44 is increased, the mass 52 of a secondary molten glass droplet obtained via collision and separation of the primary molten glass droplet is also increased.

To allow the mass of an optical element, namely a lens which is finally formed to be a desired one, the mass 52 of the secondary molten glass droplet needs to be adjusted. Therefor, it is necessary to control the mass 51 of the primary molten glass droplet and further to carry out appropriate condition settings for melting temperature 41 (viscosity 42), nozzle outer diameter 43, and opening diameter 44.

Of course, when these condition settings are carried out, in addition to the mass of an optical element, namely a lens, effects on the optical performance and the appearance quality of a finally press-molded lens also need to be considered.

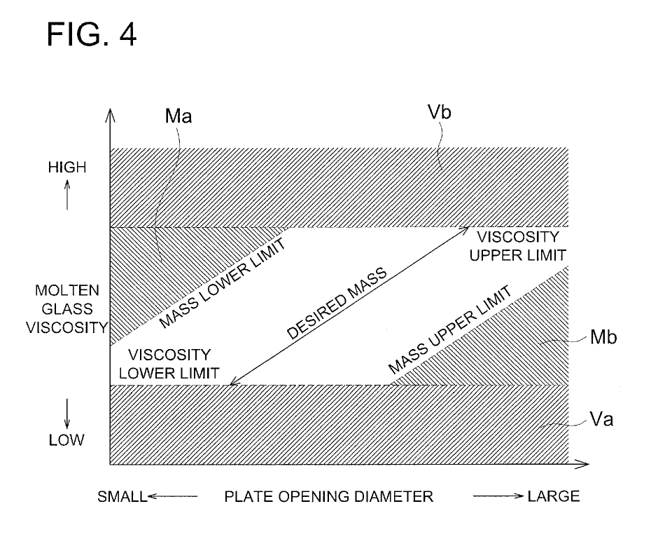

FIG. 4 is a graph schematically showing effects of typical manufacturing conditions on the quality of a molten glass article. With reference to FIG. 4, effects of molten glass viscosity 42 and plate opening diameter 44 as manufacturing conditions on the quality of an optical element will now be described.

FIG. 4 shows a plane region, constituted of the vertical axis expressing the height of the molten glass viscosity and the horizontal axis expressing the size of the plate opening diameter, with several divided regions.

Region Va shows a region with a viscosity of at most the lower limit in which the viscosity of molten glass is excessively small, whereby quality problems occur. Namely, in this region, bubbles and striae are generated, or no molding stability is expressed and thereby an appropriate surface shape tends not to be realized. Further, noted is such a problem that the dropping cycle time is excessively increased, whereby the disposal amount is increased.

Region Vb shows a region with a viscosity of at least the upper limit in which the viscosity of molten glass is excessively large, whereby quality problems occur. Namely, in this region, devitrification of glass occurs, or a primary molten glass droplet is excessively hard, whereby a fine droplet (a secondary molten glass droplet) is likely not to be separated (cannot be passed through the opening). Further, noted is such a problem that the cycle time becomes excessively long, whereby productivity is decreased.

Region Ma shows a region with a mass of at most the lower limit of a fine droplet in which the plate opening diameter is small and the viscosity is large, whereby the mass of a fine droplet (a secondary molten glass droplet) becomes excessively decreased, resulting in occurrence of quality problems. Namely, in this region, bubbles are generated during separation, or a primary molten glass droplet is likely not to be separated into a fine droplet (cannot be passed through an excessive small opening).

Region Mb shows a region with a mass of at least the upper limit of a fine droplet in which the plate opening diameter is large and the viscosity is small, whereby the mass of a fine droplet (a secondary molten glass droplet) becomes excessively increased, resulting in occurrence of quality problems. Namely, in this region, navels (air gathering spots) are generated or overflowed excess glass collides with the edge, whereby cracking occurs. Or, a primary molten glass droplet cannot be separated into a fine droplet and is likely to pass through the opening as such.

In this manner, by the viscosity upper and lower limits of molten glass and the mass upper and lower limits of a fine droplet, 4 regions where quality problems are produced are defined. Then, the central region (the blank area) surrounded by these 4 regions (the shaded areas) is a desirable region in view of quality.

In the manufacturing method of an optical element according to the present embodiment, manufacturing conditions are set so as to fall within this desirable region in view of quality. For example, it is desirable that the upper limit of viscosity be 2 Pa·s and the lower limit thereof be 0.1 Pa·s.

However, FIG. 4 is a graph showing a conceptual tendency, and setting of manufacturing conditions is not so simply carried out. A larger number of parameters are related to each other. It is unclear what parameters should be selected based on a priority basis and what procedures make it possible to carry out efficient, assured condition settings.

A schematic flow of manufacturing condition settings in the manufacturing method of an optical element of the present embodiment will now be described.

(Manufacturing Condition Setting Flow)

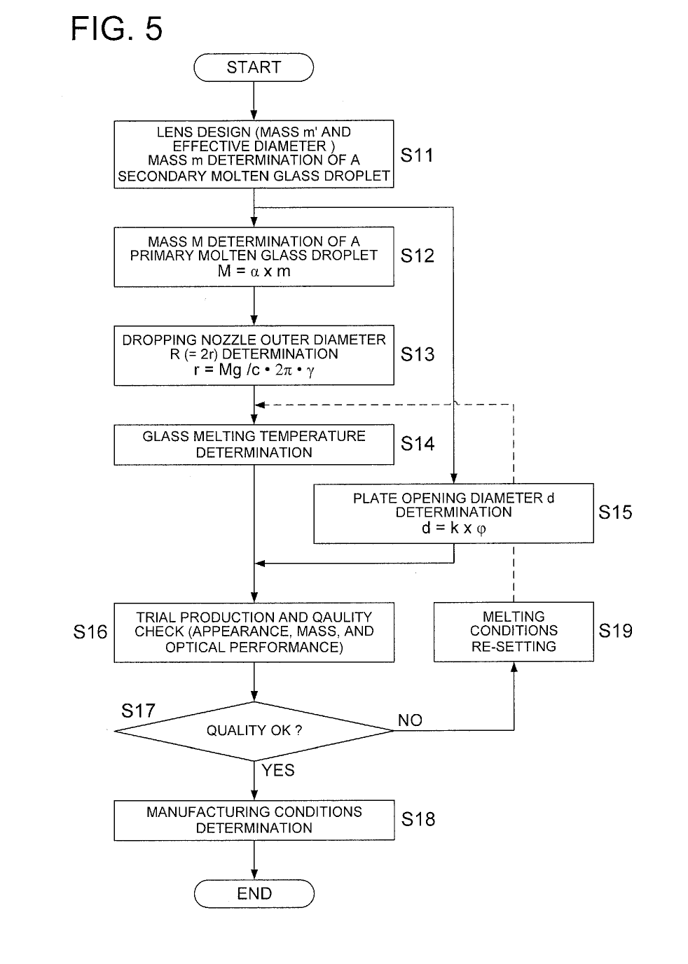

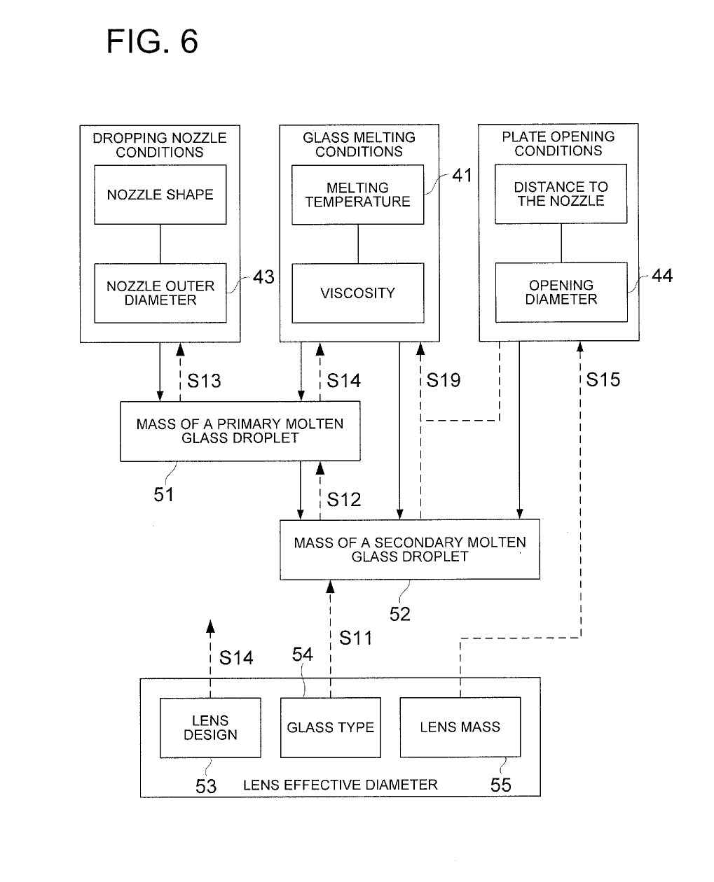

FIG. 5 is a flowchart showing a schematic procedure to set manufacturing conditions based on lens design specifications. FIG. 6 is a diagram in which a procedure to set manufacturing conditions based on lens design specifications is additionally drawn for FIG. 4. With reference to FIG. 5 and FIG. 6, a schematic procedure for the setting method of manufacturing conditions according to the present embodiment is described below.

In FIG. 5, initially, in step S11, design specifications (lens mass m′ and lens effective diameter φ) of an optical element (a lens) are determined and a desired mass m of a secondary molten glass droplet is determined. In FIG. 6, such lens design specifications are expressed by lens mass 54, lens effective diameter 55, and glass type 53. Further, as shown by a dashed arrow of S11, the mass 52 of a secondary molten glass droplet is set based on lens mass 54.

Next, in step S12 of FIG. 5, a desired mass M of a primary molten glass droplet is set to obtain a desired mass m of a secondary molten glass droplet With regard to the setting method, for example, determination is made by multiplying a desired mass m of the secondary molten glass droplet by a coefficient a having been separately determined. In FIG. 6, as shown by a dashed arrow of S12, the mass 51 of the primary molten glass droplet is set based on the mass 52 of the secondary molten glass droplet.

In step S13 of FIG. 15, to obtain a desired mass M of a primary molten glass droplet, the nozzle outer diameter R of a dropping nozzle is set. The setting method is based on an expression (r=Mg/c·2πγ). Herein, r=R/2; g represents gravity acceleration; c represents a constant; and γ represents the surface tension of a primary molten glass droplet. Since surface tension depends on the temperature of molten glass, in this step, a desired state is temporally set and then in the next step, melting temperature needs only to be adjusted. In FIG. 6, as shown by a dashed arrow of S13, a nozzle outer diameter 43 is set based on the mass 51 of the primary molten glass droplet

In step S14 of FIG. 5, in the same manner as in step S13, based on the desired mass M of a primary molten glass droplet, the melting temperature 41 of molten glass flowing out of the nozzle is set. This step S14 may be performed in parallel via a mutual adjustment with step S13. In FIG. 6, as shown in a dashed arrow of S14, melting temperature 41 is set based on glass type 53 and the mass 51 of the primary molten glass droplet.

In step S15 of FIG. 15, the opening diameter 44 of a plate is set based on lens effective diameter which is a lens design specification, independently of manufacturing condition setting with respect to the dropping nozzle from step S12-step S14, namely the mass of the primary molten glass droplet. In FIG. 6, as shown by a dashed arrow of S15, the opening diameter 44 of the plate is set based on lens effective diameter 55.

In this manner, each manufacturing condition setting is configured in a flow manner and especially, setting of plate opening diameter is allowed to be independent of other manufacturing condition settings on a priority basis, resulting in easy and assured manufacturing condition setting. As the alternative thereof; setting re-adjustment based on quality confirmation is carried out in a subsequent step. It will be described later, with reference to examples, that opening diameter is effectively set based on lens effective diameter.

In next step S16, a certain number of optical elements are trial-produced based on manufacturing conditions having been set for quality check. A production process of the optical element will be described later. Quality to be checked includes, in addition to the mass of the optical element, optical performance and appearance.

In next step S17, a judgment is made with respect to whether or not the quality having been checked is problematic. When no problem judgment has been made, then progress is made to next step S18, and manufacturing conditions are determined for termination. Thereafter, based on the manufacturing conditions having been set, full-scale operations are carried out.

In step S17, when the quality having been checked is judged to be problematic, progress is made to step S19 to reset melting conditions. In FIG. 6, as shown by a dashed arrow of S19, based on opening diameter 44 and a resulting mass 52 of the secondary molten glass droplet, melting temperature 41 is reset.

What is actually reset is may be just melting temperature which is basically easily adjusted. Since an adjustment needs only to be made so that viscosity and the mass of a molten glass droplet are non-problematic. An adjustment is made in step S14, and then procedures need only to be repeated from step 16.

A manufacturing method to manufacture optical elements based on the manufacturing conditions having been set as described above will now be described.

(Manufacturing Method of an Optical Element)

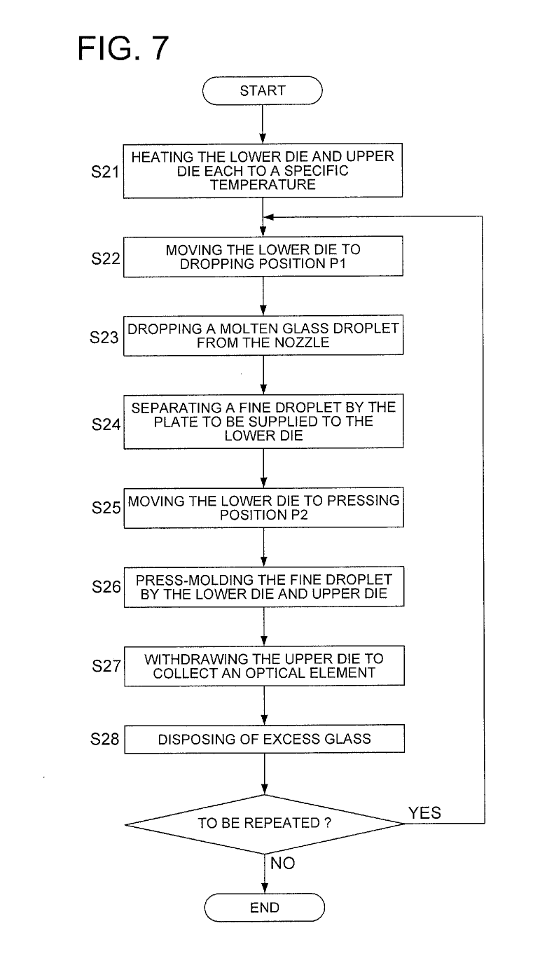

The manufacturing method of an optical element according to the embodiment of the present invention will now be described with reference to FIG. 7-FIG. 9.

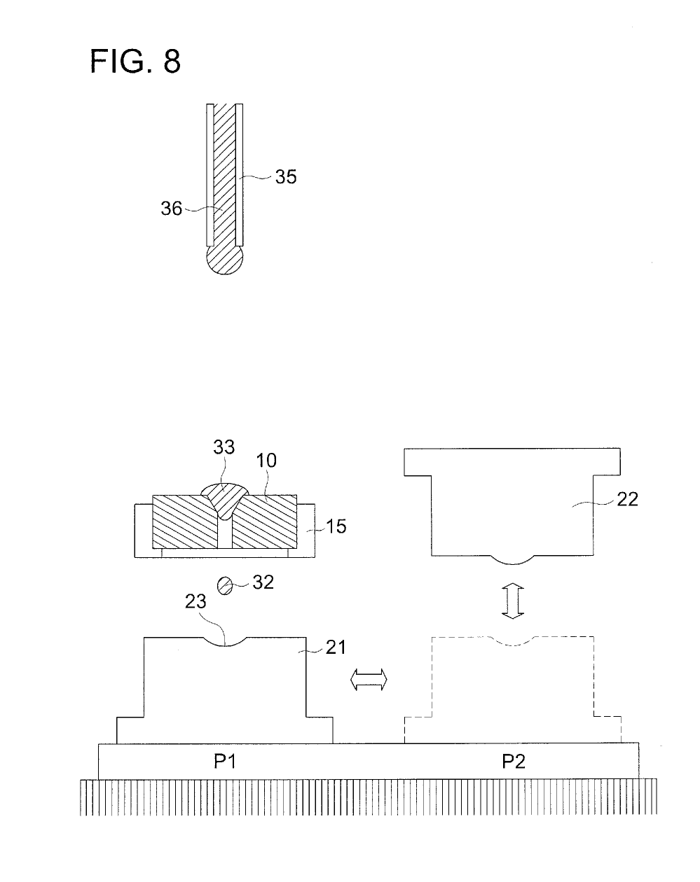

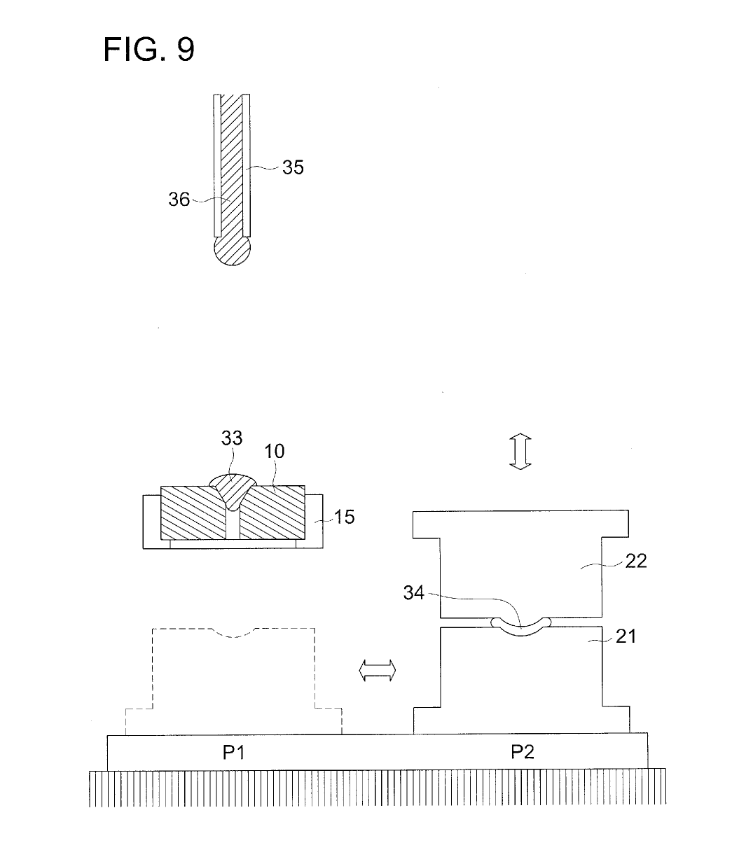

FIG. 7 is a flowchart showing one example of the manufacturing method of an optical element according to the embodiment of the present invention. Further, FIG. 8 and FIG. 9 are schematic views to illustrate the manufacturing steps of an optical element. FIG. 9 shows the state (step S24) where a fine droplet 32 is separated by the plate 10. FIG. 9 shows the state (step S26) where the fine droplet 32 is press-molded by the lower die 21 and the upper die 22.

In FIG. 8 and FIG. 9, the upper die 22 to press-mold a fine droplet 32 together with the lower die 21 is constituted in the same manner as the lower die 21 so as to be heated to a specific temperature using an unshown heating member. Such a constitution is preferable that the lower die 21 and the upper die 22 can individually be subjected to temperature control.

Further, the lower die 21 is constituted so as to be movable by an unshown drive member between the position to receive a fine droplet 32 below the plate 10 (dropping position P1) and the position to carry out press-molding together with the opposed upper die 22 (pressing position P2). Further, the upper die 22 is constituted so as to be movable by an unshown drive member in the direction of pressing the fine droplet 32 between the same and the lower die 21 (the vertical direction in the drawing).

Each step will now sequentially be described based on the flowchart shown in FIG. 7.

Initially, the lower die 21 and the upper die 22 are heated to specific temperatures (step S21). As such specific temperatures, any appropriate temperatures, at which an excellent transfer surface can be formed for an optical element via press-molding, need only to be selected. The heating temperatures of the lower die 21 and the upper die 22 may be the same or differ.

Subsequently, the lower die is moved to the dropping position (the position P1 shown in FIG. 9) (step S22).

Then, a primary molten glass droplet 31 is dropped from the nozzle 35 (step S23). The primary molten glass droplet 31 is dropped as follows: primary molten glass 36 having been heated in an unshown melting furnace is supplied to the nozzle 35, and in this state, the nozzle 35 is heated to a specific temperature; and thereby, the primary molten glass 36 passes, under its own weight, through the flow channel provided in the nozzle 35 to be accumulated in the tip portion via surface tension. When a certain mass of the molten glass is accumulated, the molten glass is separated from the tip portion of the nozzle 35 on its own and then a certain mass of the primary molten glass droplet 31 having been set is dropped downward.

The mass of the primary molten glass droplet 31 dropping has been previously set but is adjustable by the outer diameter of the tip portion of the nozzle 35. Further, the dropping interval of the primary molten glass droplet 31 can be adjusted by the inner diameter, length, and heating temperature of the nozzle 35. The procedures to appropriately set these conditions are as described above. By setting these conditions, a desired mass of the primary molten glass droplet 31 can be dropped in a desired interval.

The mass of the primary molten glass droplet 31 dropping from the nozzle 35 has been set to be a magnitude which is larger than that of a desired fine droplet 32 and also makes it possible to separate the fine droplet 32 via collision with the opening 11 of the plate 10.

Then, the fine droplet 32 is separated by the plate 10 to be supplied to the lower die 21 (step S24). When the primary molten glass droplet 31 collides with the upper surface 12 of the plate 10, then via the impact, a part of the primary molten glass droplet 31 passes through the opening 11 having a set opening diameter to be separated as a (secondary molten glass) fine droplet 32.

The temperature of the primary molten glass droplet 31 on collision with the plate 10 has been set to be a temperature enabling to decrease viscosity to the extent that the fine droplet 32 can be separated via this impact.

Further, the impact force on the impact also varies with the distance between the tip of the nozzle 35 and the plate 10. Therefore, the distance is appropriately selected so as to conform to the above temperature condition, whereby a desired mass of the fine droplet 32 can be obtained.

Above step S23 and step S24 are designated as a molten glass droplet supply step.

Next, the lower die 21 is moved to the pressing position P2 (step S25) and the upper die 22 is moved downward, whereby the fine droplet 32 is press-molded by the lower die 21 and the upper die 22 (step S26).

The fine droplet 32 having been dropped (supplied) onto the lower die 21 is cooled and solidified during press-molding via heat release from the lower die 21 and the contact surface with the upper die 22. Cooling is carried out to a temperature in which the shape of a transfer surface having been formed in a molten glass article 34 is not broken even after release of pressing, and thereafter pressing is released.

Above step S25 and step S26 are designated as a press-molding step.

Subsequently, the upper die 22 is withdrawn to collect an optical element 34 (step S27) and excess glass 33 having been allowed to remain in the plate 10 is disposed of (step S28) to complete the production of the optical element. Thereafter, another optical element is successively produced, the lower die 21 is moved again to the dropping position P1 (step S22 ) and then step S23-step S28 need only to be repeated.

Herein, the manufacturing method of an optical element of the present invention may contain other steps other than the steps having been just described. For example, a step to inspect the shape of an optical element before collecting the optical element and a step to clean the lower die 21 and the upper die 22 after collecting the optical element may be provided.

Optical elements manufactured by the manufacturing method of the present invention can be used as various types of optical elements such as imaging lenses for digital cameras, optical pick-up lenses for DVDs, and optical communication coupling lenses.

### EXAMPLES

Using the apparatus and the method as described above, trial manufacturing of optical elements was carried out.

Lens design is carried out for a biconvex aspherical lens having an outer diameter of φ5, an effective diameter of φ3.8, and a lens mass of 75 mg. As a glass material, SK57 was used.

As the lower die and the upper die, those processed into a specific aspherical shape based on the above design were used.

The desired mass of a fine droplet of secondary molten glass to be press-molded was allowed to be 80 mg, and the mass of a primary molten glass droplet to obtain this fine droplet was set to be 400 mg.

To drop 400 mg of the primary molten glass droplet, a dropping nozzle made of Pt having a set outer diameter of φ8 was used. Glass melting temperature was adjusted at about 1100° C. to obtain a desired mass of the fine droplet.

Several opening diameters of the plate were set in the range of 50%-100% of a lens effective diameter of φ3.8. Further, as comparative examples, settings less than 50% and more than 100% were conducted.

In Table 1, the plate opening diameters in example 1-example 6, as well as comparative example 1 and comparative example 2 and the ratios with respect to the lens effective diameters were listed. Further, melting temperatures and the quality evaluation results of molded optical elements are shown together.

TABLE 1

| | Manufacturing Conditions | | | Quality | |
|---|---|---|---|---|---|
| | | Ratio | Molten | | Optical |
| | Plate | to | Glass | Appear- | Perform- |
| | Opening | Effective | Tem- | ance | ance |
| | Diameter | Diameter | perature | Quality | (Surface |
| | (mm) | (%) | (° C.) | (Navel) | Accuracy) |
| Example 1 | 1.9 | 50 | 1367 | A | B |
| Example 2 | 2.6 | 68 | 1200 | A | B |
| Example 3 | 2.9 | 76 | 1170 | A | A |
| Example 4 | 3.2 | 84 | 1090 | A | A |
| Example 5 | 3.6 | 95 | 1000 | B | A |
| Example 6 | 3.8 | 100 | 950 | B | A |
| Com- | 1.7 | 45 | 1410 | A | C |
| parative | | | | | |
| Example 1 | | | | | |
| Com- | 4.0 | 105 | 913 | C | A |
| parative | | | | | |
| Example 2 | | | | | |

In Example 1-Example 6, 6 opening diameters therefor were set each from φ1.9-φ3.8 (ratios to an effective diameter of φ3.8 ranged from 50%-100%), and in Comparative Example 1 and Comparative Example 2, setting was made at φ1.7 and φ4 (ratios to an effective diameter of φ3.8 were 45% and 105%).

Opening diameter settings differ, whereby the mass of a fine droplet of secondary molten glass obtained varies. To adjust this fact, primary glass melting temperature was changed. The results are also shown in Table 1.

Under the above conditions, a fine droplet having been dropped onto the lower die was pressed by the upper die for press-molding to manufacture an optical element. In each Example and Comparative Example, a certain number of optical elements were trial-produced for quality evaluation.

In quality evaluation, appearance quality (especially, the occurrence rate of air gathering spots called navels) and optical performance (especially, surface accuracy) were rank-evaluated in 3 levels of A, B, and C. A represents specifically excellent quality and B represents quality in an acceptable range. C represents unacceptable quality. These evaluation results are also shown in Table 1.

From the evaluation results, in Example 1-Example 6, every evaluation result with respect to appearance quality and optical performance falls within the acceptable range, while the difference of A or B appears in evaluation depending on each opening diameter setting. In Comparative Example 1 and Comparative Example 2, in either appearance quality or optical performance, C, namely unacceptable quality is shown.

Quality difference is shown even among Examples whose evaluation results fall within the acceptable rage. For example, with regard to appearance quality, in Example 4, even after 10000 shot trial-production, no navels were generated (evaluation A). However, in Example 5, when exceeding 1000 shots, navel generation was noted (evaluation B).

Of Examples, Example 3 and Example 4 are ranked as A, each exhibiting namely specifically excellent results with respect to both appearance quality and optical performance. Therefore, it is conceivable that the ratio of the opening diameter to the lens effective diameter is preferably set from 70%-90%, whereby such a specifically excellent result is realized.

In this manner, in setting of manufacturing conditions, the opening diameter of the plate is effectively set based on the lens effective diameter. Further, as having been described above, when each manufacturing condition is set in a procedure manner, and especially, setting of the plate opening diameter is allowed to be independent of other manufacturing condition settings and to be carded out on a priority basis, these manufacturing condition settings are easily and assuredly carried out.

Namely, according to the manufacturing method of an optical element of the present embodiment, in a manufacturing method of an optical element in which a primary molten glass droplet is allowed to collide with a plate to separate a part thereof and a fine droplet of secondary molten glass having passed through an opening is dropped onto a lower molding die and press-molded, when the opening diameter of the plate is conditionally set to be 50%-100% of the effective diameter of an optical functional surface provided for the lower molding die, manufacturing conditions of a secondary molten glass droplet are easily and appropriately set, whereby an optical element enabling to satisfy both qualities of appearance quality and optical performance can stably be produced.

Herein, the scope of the present invention is not limited to the above embodiments. Various modified embodiments thereof also fall within the above scope without departing from the spirit of the present invention.

1. A manufacturing method of an optical element comprising:
a molten glass droplet supply step for dropping a primary molten glass droplet from a dropping nozzle onto an opening member having an opening and receiving a part of the primary molten glass droplet having passed through the opening as a secondary molten glass droplet by a lower molding die arranged immediately below the opening member; and
a press-molding step for pressing the secondary molten glass droplet having been dropped on the lower molding die by an upper molding die, wherein an opening diameter of the opening member is 50%-100% of an effective diameter of an optical functional surface provided for the lower molding die.

2. The manufacturing method of an optical element, described in claim 1, wherein the opening diameter of the opening member is 70%-90% of the effective diameter of the optical functional surface provided for the lower molding die.

3. The manufacturing method of an optical element, described in claim 1, wherein the viscosity of the primary molten glass droplet is 0.1 Pa·s-2 Pa·s.

4. The manufacturing method of an optical element described in claim 3, wherein the opening diameter of the opening member is set based on the effective diameter of the optical functional surface provided for the lower molding die; the outer diameter of the dropping nozzle to drop the primary molten glass is set to obtain a desired mass of a primary molten glass droplet; and the desired mass of the primary molten glass droplet is set to obtain a desired mass of a secondary molten glass droplet.

5. The manufacturing method of an optical element, described in claim 4, wherein the melting temperature of the primary molten glass droplet is set based on the desired mass of the primary molten glass droplet.

6. The manufacturing method of an optical element, described in claim 5, wherein an optical element is trial-produced based on manufacturing conditions set by the method described in claim 5 and the quality of a trial-produced optical element is checked to reset the melting temperature.

7. A manufacturing apparatus of an optical element comprising:
a nozzle dropping nozzle to which drops a primary molten glass droplet;
an opening member as a droplet amount adjustment member, the opening member having an opening which separates and passes a part of the primary molten glass droplet having been dropped from the dropping nozzle and drops the part of the primary molten glass as a secondary molten glass droplet;
a lower molding die arranged immediately below the opening of the opening member to receive a drop of the secondary molten glass droplet having passed through the opening; and
an upper molding die which presses and molds the secondary molten glass droplet having been dropped on the lower molding die,
wherein an opening diameter of the opening member is 50%-100% of the effective diameter of an optical functional surface provided for the lower molding die.

8. The manufacturing apparatus of an optical element, described in claim 7, wherein the opening diameter of the opening member is 70%-90% of the effective diameter of the optical functional surface provided for the lower molding die.

9. The manufacturing method of an optical element, described in claim 2, wherein the viscosity of the primary molten glass droplet is 0.1 Pas·s-2 Pa·s.
